(19) United States
(12) Patent Application Publication
(10) Pub. No.: US 2010/0300745 A1
(43) Pub. Date: Dec. 2, 2010

(54) Metering Enclosure With Specially Hinged Front Cover

(76) Inventors: Richard R. Boyle, Milwaukee, WI (US); Christopher T. Niemuth, Grafton, WI (US); Ivo Tomas, Brno (CZ)

Correspondence Address: BOYLE FREDRICKSON S.C., 840 North Plankinton Avenue, MILWAUKEE, WI, 53203, US

(21) Appl. No.: 12/472,548

(22) Filed: May 27, 2009

(51) Int. Cl. H01R 13/46

(52) U.S. Cl. 174/520

(57) ABSTRACT

A hinged enclosure using two ball-headed screws (16a, 16b) at the corners of a rectangular cover (12) and two other fasteners (16c, 16d). The other two fasteners (16c, 16d) and the ball-headed screws (16a, 16b) are loosened to allow the cover (12) to be moved first outwardly away form the enclosure body (11) and the other two fasteners are then removed to allow the cover (12) to be pivoted around the two loosened ball-headed screws (16a, 16b). There are stand-offs (20a-20d) at the corners of the enclosure body (11) to restrict movement of the cover (11) until the cover (11) is moved away from the body (11), and before pivoting the cover (12) on the ball-headed screws (16a, 16b). There is a seal (21) around the rim of the cover (12), such that the cover (12) must be lifted first, before the cover (12) is pivoted. The cover (12) contains an electronic display and a display circuit board module (19) is attached on the underside of the cover and these must be protected when the cover (12) is opened during service or installation.

### TECHNICAL FIELD

This invention relates to enclosures for magnetic metering equipment for use in an industrial environment where sealing of the enclosure against the environment is required and a specific environmental rating is essential.

### DESCRIPTION OF THE BACKGROUND ART

There is a requirement for easier servicing of equipment inside a sealed, environmentally rated enclosure, during installation in an industrial environment. Mag meters are used on potable liquid lines or for measurement of liquids such as reclaimed water or raw sewage, or where the meter location is difficult for maintaining the meter, or when increased accuracy is paramount. There is a need for better serviceability of the electronics during installation and a need to achieve a specific environmental rating.

These enclosures typically have a body with an interior cavity and a front or top cover. Typically, there is a numerical display on the front cover and a circuit board may be attached to an underside of the front cover. It is important that when the cover is opened that the seal not be damaged, so that the cover can be closed again while maintaining the seal. The cover must sometimes be opened for access and testing of the electronics inside.

Weisz et al., U.S. Pat. No. 3,714,678, discloses a basic ball joint for use in hinges in a sewing machine. As seen in FIG. 1, the screw has a full spherical ball portion connected to a threaded shaft. In Weisz, the ball is inserted into a groove and the inserts are then positioned to trap the ball in the groove.

Lutz, U.S. Pat. No. 4,109,821, shows a box with a lid hinged to a body with integrally formed spherical ball head members that are received in externally projecting sockets that allow a cover of the box to pivot to an open position.

Motyka et al., U.S. Pat. No. 4,785,496, provides ball-and-socket hinged joints for a plate assembly in which the ball can travel in a groove to allow translational movement before the plate is pivoted. The ball is not externally accessible and the hinges project significantly above the plate assembly for a non-flush construction.

Akkala et al., U.S. Pat. No. 7,094,000, shows a single ball socket hinge for a sewer lid in various types of sewer apparatus to allow pivoting in more than one direction.

Fowler et al., U.S. Pat. No. 6,302,612 shows application of ball-in-socket connectors to a laptop computer, to pivot the screen, for example.

None of the above prior art constructions provides the combination of features provided by the present invention in addition to low manufacturing cost.

### SUMMARY OF THE INVENTION

The present invention is incorporated in a hinged enclosure using two ball-headed screws at the corners of a rectangular cover and using two other fasteners. The screws and other fasteners are loosened to allow the cover to be moved outwardly of the body, and the fasteners are then removed so that the cover can then pivoted around the two loosened ball-headed screws. There are restrictions at the corners of the enclosure body to restrict pivoting of the cover until it has been moved a distance away from the body to a partially open position, before pivoting the cover on the ball-headed screws to a fully open position. There is a seal around the lip of the cover, such that the cover must be moved linearly first, before the cover is pivoted.

In a preferred embodiment, the cover contains an electronic display and a display circuit board is attached on the underside of the cover. The invention prevents the cover and display from dangling by a ribbon cable connecting the display to the bottom box electronics. This could cause the cable to be damaged or the cover to drop as a result of the ribbon cable separating from the electronics.

In one aspect of the invention, custom-made hemispherical ball-headed screws are used to provide a hinged connection at two corners. The hinges are disposed inside the cover to provide a flush outer surface, with recessed holes for accessing the screws with a tool.

Restrictions are provided at the corners of an enclosure body so that the cover must be translated in a linear movement away from the body, before pivoting the cover on the ball-headed screws. It should be apparent that restrictions are only necessary at the hinging corners to restrict pivoting during movement to a first partially open position, but for appearances and standardization and better operation, restrictions are provided at all four corners. Preferably, the restrictions are provided by stand-offs in the form of small upstanding projections molded into the enclosure body at the four corners. The stands-offs are also used to align the cover to the bottom to aid in sealing repeatability.

The invention allows access to the interior of the enclosure during installation, testing and servicing without damaging the seal. This provides an enclosure that can obtain the necessary sealing rating for the environments in which it is used.

The enclosure can have various installation orientations without departing from the scope of the invention.

The invention provides a flush front cover in which the hinge parts are not visible and in which the hinge parts do not project forward of a front surface of the cover.

In a more detailed embodiment of the invention, the other two fasteners are also ball-headed screws providing for standardization of parts and possible hinged opening and closing along two sides of the enclosure body.

Other aspects of the invention, besides those discussed above, will be apparent to those of ordinary skill in the art from the description of the preferred embodiments which follows. In the description, reference is made to the accompanying drawings, which form a part hereof, and which illustrate examples of the invention.

### BRIEF DESCRIPTION OF THE DRAWINGS

FIG. 1 is a perspective view of an enclosure of the present invention with the cover being closed;

FIG. 2 is a perspective view of the enclosure of FIG. 1, with the cover in the fully open position;

FIG. 3 is a sectional view of the enclosure taken in the plane indicated by line 3-3 in FIG. 1;

FIG. 4 is a break-away portion of FIG. 3 showing a first part of the opening motion in an area of two ball screws forming a hinge for the cover;

FIG. 5 is a detail view of one hinged corner of the enclosure in the fully open position, with the initial, partially open position shown in phantom;

FIGS. 6 and 7 are detail views of one of the stand-offs located at the four corners of the enclosure body portion;

FIG. 8 is a sectional view taken in the plane indicated by line 8-8 in FIG. 5 shown a non-hinged corner of the enclosure; and

FIG. 9 is a detail view of a second hinged corner of the enclosure in the fully open position, with the initial, partially open position shown in phantom.

### DETAILED DESCRIPTION

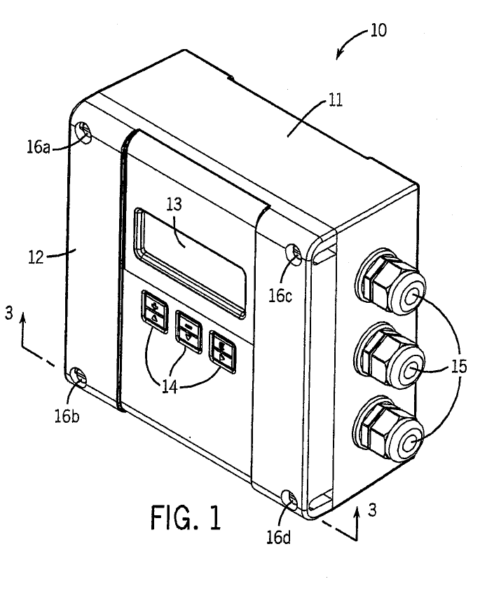

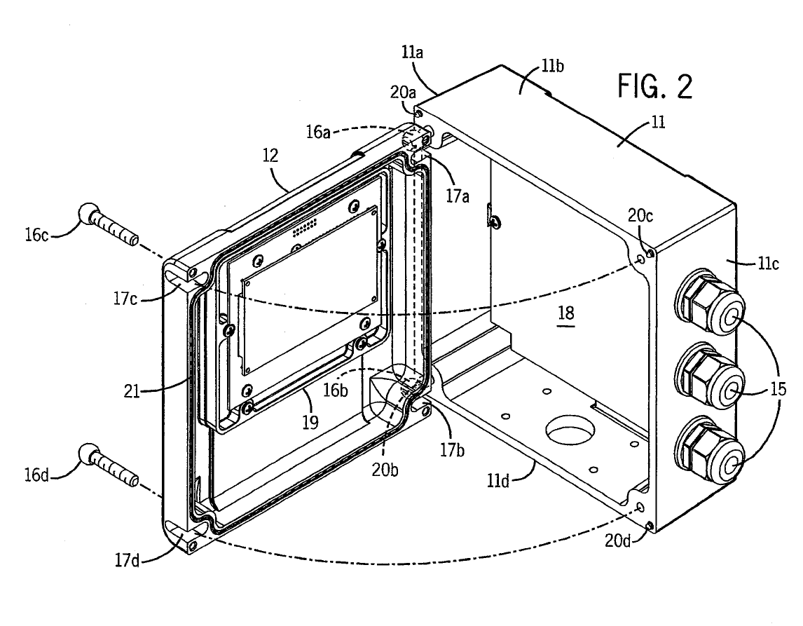

FIG. 1 shows a mag meter enclosure 10. Mag meters are used on potable liquid lines or for measurement of liquids such as reclaimed water or raw sewage, or where the meter location is difficult for maintaining the meter, or where increased accuracy is paramount. The enclosure 10 includes an enclosure body 11 and a cover 12 that is hinged to the body and fastened down as will explained in more detail below. A window 13 for a visual display is provided on the front cover 12 along with three touch pad switches 14. The display and switches 14 are electrically connected to a circuit board in a circuit board module 19 positioned behind the cover 12 as seen in FIGS. 2, 3 and 4. As seen in FIG. 1, the enclosure 10 has three terminals 15 for connection of electrical wires (not shown).

The invention concerns the mounting of the cover 12 to the body 11 of the enclosure. The cover 12 is fastened to the body 11 by four screws 16a-16d positioned in the four corners of the cover 12. As seen in FIG. 2, two of the screws 16c and 16d can be unscrewed to release the two right-hand corners of the cover 12. The cover 12 can then be pivoted on a hinge formed by two screws 16a and 16b and certain grooves formed in the cover 12. When the cover 12 is moved to a fully open position, a hollow cavity 18 in the body 11 is accessible. The cavity 18 is surrounded by the four sides 11a-11d of the body 11. It can be seen in FIG. 2 that the circuit board module 19 is carried on the back of the cover 12. Also, a seal 21 of resilient sealing material is disposed in a loop around a periphery of the cover 12. The seal 21 is held between the cover 12 and the body 11, when the cover is fully closed against the body 11. To protect the seal 21 when the cover is opened, the cover 12 must first be translated forward in a linear direction from the body 11 until the cover 12 clears the stand-offs 20a-20d projecting from the body 11 at the four corners of the body 11. After clearing the stand-offs 20a-20d, the cover 12 can then be pivoted along a left side as shown in FIG. 2. It would also be possible to pivot the cover along a right hand side 11c of the body 11, or if the orientation of slots 17a-17d were modified along the top edge 11b or along the bottom edge 11d of the enclosure body 11.

It should be apparent that only two stand-offs 20a-20d are necessary to restrict an initial movement of the cover 12 relative to the pivoting elements, but for standardization of parts and better balance, four stand-offs 20a-20d are provided at four respective corners of the enclosure cover 12. These take the form of small upstanding projections 20a-20d molded into the enclosure cover 11 at the four corners.

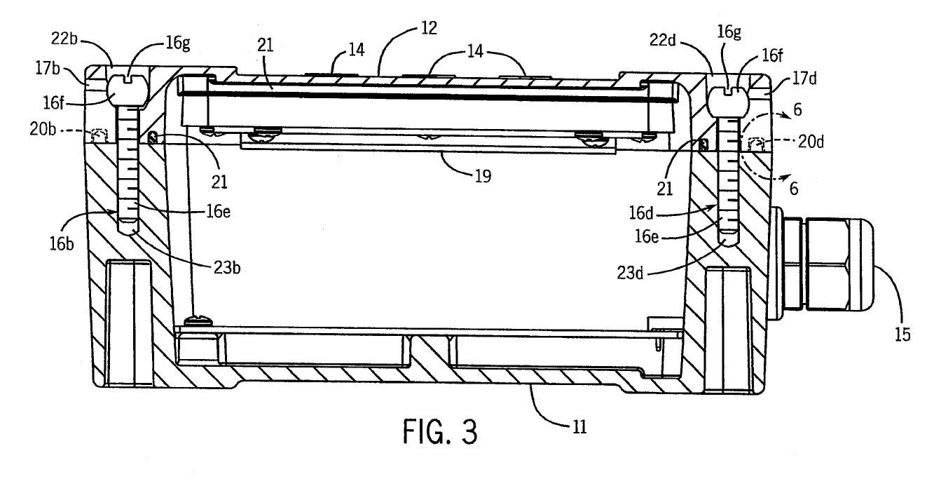

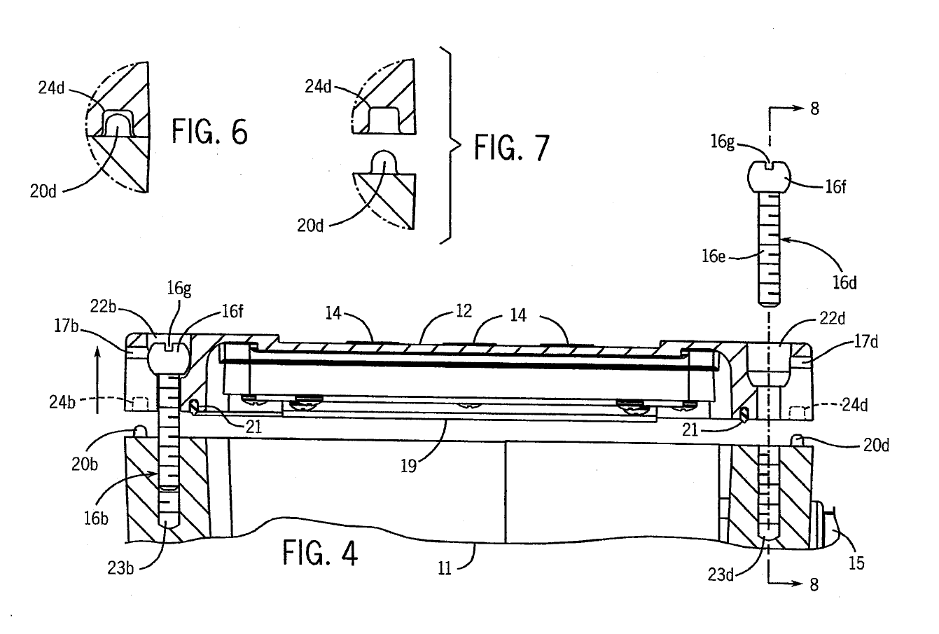

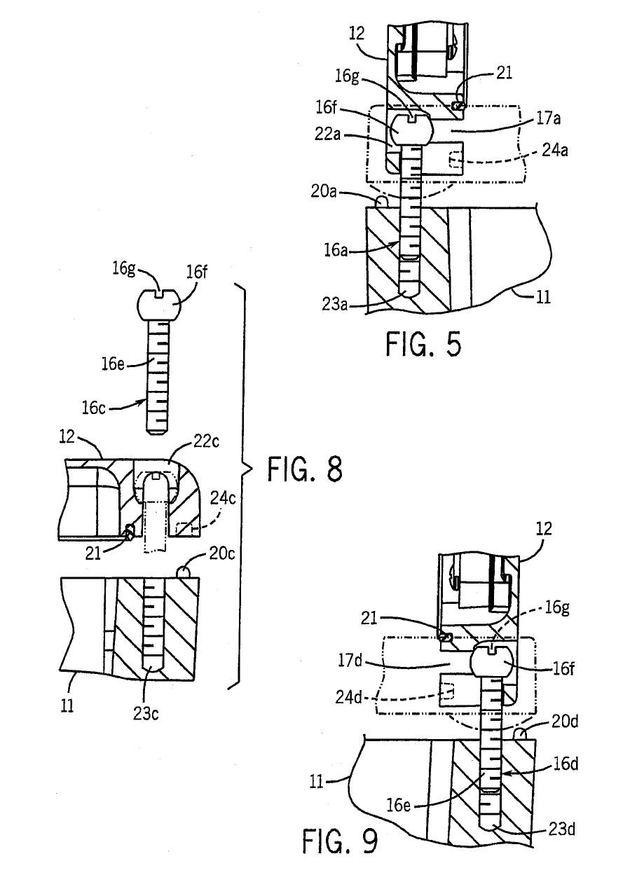

The screws 16a-16d are loosened from the position seen in FIG. 3 to the position shown in FIG. 4. After the cover 12 is moved away from the body 11 with the seal 21, two of the screws 16c and 16d are removed to release the right-hand side of the cover 12. The screws 16a-16d are ball-headed screws, each having a ball-shaped head 16f and a threaded shaft 16e. The ball-shaped heads are not perfectly ball-shaped, but are flattened on top and provided with a slot 16g that is added to receive a bit of a screwdriver. When screwed into holes 22a-22d in the body 11, the heads 16f of the screws 16a-16d are received in recessed, counterbored holes 22a-22d extending through the corners of the cover 12, with the shaft 16e of the screws 16a-16d being received in threaded hole extensions 23a-23d in the body 11. At the two left-hand side corners are slots 17a and 17b seen in FIGS. 5 and 9 that intercept the screw holes 22a, 22b at a right angle. These intersections of the slots 17a, 17b and the screw holes 22a, 22b form complex cavities that allow the corners of the cover 12 to pivot around the ball-heads 16f of the screws 16a and 16b as seen in FIGS. 5 and 9 to the fully open position seen in FIG. 2.

FIG. 4 shows the first, partially open position in which the cover 12 is moved linearly away from the body 11 to clear the stand-offs 20a-20d. The two right-hand side corners have similar slots 17c and 17d intersecting recessed holes 22c and 22d, but since the cover 12 is being pivoted around a left hand side hinge, these slots 17c and 17d are not being used for a pivoting purpose. This is to standardize manufacturing steps by making holes and slots at all four corners the same and to allow the cover 12 to be opened on a hinge on either the right-hand side or the left-hand side. It should be apparent that in alternative embodiments only two of the four corners need to be provided with hinges.

FIGS. 6 and 7 shows one of the stand-offs 20d in detail and how it is received in a corresponding recess 24d in the cover 12, when the cover is in the closed position seen in FIG. 1. The other three stand-offs 20a-20c are similarly received in corresponding recesses 24a-24c seen in FIG. 2.

In opening the cover 12, first, all four screws 16a-16d are loosened to allow the cover 12 to be translated upwardly or forwardly away from the body 11 to clear the stand-offs 20a-20d and to reach a partially open position. This protects a seal 21 on a back side of the cover 12 from being damaged and it also protects a ribbon cable that is connected to the circuit module 19. It may be necessary to open the cover 12 as part of the process of installing equipment in a water processing system. Two of the screws 16c and 16d are then completely removed to allow the cover 12 to pivot or hinge on the remaining two screws 16a and 16b to the fully open position seen in FIG. 2. To close the cover 12, the steps are reversed, with the cover 12 being pivoted into position over the body 11, being moved linearly inward and onto the stand-offs 20a-20d and the screws 16a to 16d being inserted and secured in the counterbored holes to secure the cover in its closed position.

It can be seen from this description, how the invention provides a flush front cover in which the hinge parts are not visible and in which the hinge parts do not project forward of a front surface of the cover. It can also be seen how the structure provides an opening motion that protects the seal and the electronic module attached to the cover.

This has been a description of a preferred embodiment, but it will be apparent to those of ordinary skill in the art that variations may be made in the details of these specific embodiments without departing from the scope and spirit of the present invention, and that such variations are intended to be encompassed by the following claims.

We claim:

1. A sealed enclosure for containing electronics, the enclosure comprising:
an enclosure body having a hollow cavity surrounded by four sides that form four corners;
wherein the enclosure body has respective stand-offs located at a minimum of two of four respective corners and projecting outwardly therefrom;
a cover for the enclosure, the cover having four corresponding sides and a seal that is disposed around the four corresponding sides of the cover;
the cover also forming four corners corresponding in position to the four respective corners of the enclosure body;
wherein there are at least two recessed holes in a respective two of the four corners of the enclosure cover that are aligned with hole extensions in the enclosure body;
wherein respective ball-headed screws are positioned in the recessed holes in two of the four corners of the enclosure cover;
wherein there are two slots in the two of the four corners of the enclosure cover, the two slots each intersecting one of the recessed holes at a right angle to provide a complex cavity that allows a respective corner of the cover to be pivoted around a respective one of the ball-headed screws; and
wherein when two other corners of the four corners are released, the cover can be moved linearly away from the enclosure body to a partially open position until the stand-offs are cleared, and then pivoted around the ball-headed screws to a fully open position.

2. The enclosure of claim 1, wherein the ball-headed screws each have a substantially flat top and have a screwdriver slot in said top that is accessible in the recessed hole.

3. Then enclosure of claim 1, wherein there are stand-offs located at all four of the respective corners and project outwardly therefrom.

4. The enclosure of claim 1, wherein the two other corners of the cover are fastened to the body when the cover is closed, and released to allow the cover to be moved linearly away form the enclosure body until the stand-offs are cleared.

5. The enclosure of claim 4, wherein the two other corners of the cover are fastened with ball-headed screws, and wherein all four corners of the cover are provided with recessed holes and respective slots intersecting the recessed holes at a right angle to allow the cover to be pivoted along any side defined by two of the four corners of the cover and the enclosure body.

6. The enclosure of claim 1, wherein stand-offs are provided by upstanding projections molded into the enclosure body at the four corners.

7. The enclosure of claim 1, wherein a circuit board is mounted on a back side of the cover.

8. The enclosure of claim 1, wherein there are recesses in a back side of the cover for receiving the stand-offs when the cover is closed against the body;

9. The enclosure of claim 1, wherein the ball-headed screws are accessible with a tool inserted in the recessed holes in the cover.

10. The enclosure of claim 9, wherein the cover provides a flush outer surface except for the recessed holes and openings for electronic input and output devices.

11. The enclosure of claim 10, wherein a circuit board is mounted on a back side of the cover.

12. A sealed enclosure for containing electronics, the enclosure comprising:
an enclosure body having a hollow cavity surrounded by four sides that form four corners;
a cover for the enclosure, the cover having four corresponding sides;
the cover also forming four corners corresponding in position to the four respective corners of the enclosure body;
a seal that is disposed around the four corresponding sides of a back side of the cover;
wherein the enclosure body has restriction means located at a minimum of two of four respective corners and projecting outwardly therefrom to restrict pivoting of the cover until the cover and the seal have been moved a predetermined distance away from the enclosure body;
wherein respective ball-headed screws are positioned in the two of the four corners of the enclosure cover in complex cavities within the cover that fasten the cover to the enclosure body and when loosened, allow the cover to be pivoted around two of the respective ball-headed screws; and
wherein when two other corners of the four corners are released, the cover is configured to be moved linearly away from the enclosure body to a partially open position until the restriction means are cleared, so that the cover can be pivoted around the ball-headed screws to a fully open position.

13. The enclosure of claim 12, wherein the ball-headed screws each have a substantially flat top and have a screwdriver slot in said top.

14. The enclosure of claim 12, wherein there are restriction means are located at all four of the respective corners and project outwardly therefrom.

15. The enclosure of claim 14, in which the restrictions means are provided by stand-offs at the four corners of the enclosure body that provide positioning for the seal and alignment for the cover when re-attaching the cover to the enclosure body.

16. The enclosure of claim 12, wherein the two other corners of the cover are fastened to the body when the cover is closed, and released to allow the cover to be moved linearly away form the enclosure body until the restriction means are cleared.

17. The enclosure of claim 12, wherein the complex cavities are provided by recessed holes and respective slots intersecting the recessed holes at a right angle to allow the cover to be pivoted along any side defined by two of the four corners of the cover and the enclosure body.

18. The enclosure of claim 17, wherein the ball-headed screws are accessible with a tool inserted in the recessed holes in the enclosure cover.

19. The enclosure of claim 18, wherein the cover provides a flush outer surface except for the recessed holes and openings for electronic input and out devices.

20. The enclosure of claim 19, wherein a circuit board is mounted on a back side of the cover.
